(19) United States
(12) Patent Application Publication
(10) Pub. No.: US 2024/0210598 A1
(43) Pub. Date: Jun. 27, 2024

(54) FLEXIBLE DISPLAY DEVICE

(71) Applicant: WUHAN CHINA STAR OPTOELECTRONICS SEMICONDUCTOR DISPLAY TECHNOLOGY CO., LTD., Wuhan, Hubei (CN)

(72) Inventor: Xijuan Dai, Wuhan, Hubei (CN)

(73) Assignee: WUHAN CHINA STAR OPTOELECTRONICS SEMICONDUCTOR DISPLAY TECHNOLOGY CO., LTD., Wuhan, Hubei (CN)

(21) Appl. No.: 17/759,377

(22) PCT Filed: Jul. 6, 2022
(86) PCT No.: PCT/CN2022/104023

§ 371 Date: Jul. 24, 2022

(30) Foreign Application Priority Data
Jun. 10, 2022 (CN) 202210657342.5

(51) Int. Cl. G02B 1/14

(52) U.S. Cl. CPC G02B 1/14

(57) ABSTRACT

An embodiment of the present disclosure provides a flexible display device. The flexible display device includes a display module and a light enhancement layer. The light enhancement layer includes a hardened layer and an anti-reflective layer. A refractive index of the hardened layer is greater than a refractive index of the anti-reflective layer. The light enhancement layer is disposed in a bendable region of the display module to reduce a visual effect of creases, and a film layer structure is changed to reduce the creases of the bendable region and improve a display effect.

### TECHNICAL FIELD

The present disclosure relates to a manufacturing field of a display panel, and more particularly, to a flexible display device.

### BACKGROUND

With the development of a display technology, such as a manufacturing process of a display panel or the like, higher requirements are put forward on performance and quality of the display panel and a device thereof.

With the development and maturity of flexible materials, mobile phone devices with a flexible foldable organic light emitting diode (OLED) devices are becoming more and more popular in a high-end mobile phone in recent years. More and more mobile phone manufacturers are investing in the development of flexible foldable mobile phones. Since a flexible display panel has a better bending performance, the flexible display panel may be bent or folded to a certain extent according to different use conditions. Therefore, the flexible display panel is widely used in various fields. However, the bending performance of the flexible display panel will directly affect the quality of the flexible display panel. A structure of a flexible foldable module is usually used inside a flexible display panel, and the flexible foldable module generally has a structure in which modules are stacked. When the flexible display panel formed by multi-layer modules is bent, a larger bending stress occurs at a bendable region. Therefore, when the flexible display panel is bent, a larger number of creases often occurs in the bendable region. When the flexible display panel displays images, the display effect of the bendable region is greatly affected by the creases. Moreover, because of a weaker bending performance of a current module, a larger stress needs to be applied to bend the flexible display panel. When the applied force is too large, the number of creases in the bending stress is further increased, and the number of creases in the bendable region is further increased, so that the display effect in the bendable region is reduced, and an overall performance of the display panel is further hindered from being improved.

Therefore, a problem existing in the prior art needs to be solved.

### Technical Problems

In sum, in the flexible display panel in the prior art, the bending performance of the flexible foldable module inside the flexible display panel is poor, and many creases occurs in the bendable region, which goes against the improvement of the display effect of the bendable region and the overall performance of the display panel.

### Technical Solutions

In order to solve the above-mentioned problem, in an embodiment of the present disclosure, a display device is provided to effectively improve problems such as more creases in a bendable region and undesirable display effect when the display device is bent.

In order to solve the above-mentioned problem, the present disclosure provides a flexible display device comprising:
a bendable region and a flat region disposed at at least one side of the bendable region, the flexible display device comprising:
a display module; and
a light enhancement layer disposed on the display module and disposed at least in the bendable region;
wherein the light enhancement layer comprises a hardened layer and an anti-reflective layer disposed on the hardened layer, the anti-reflective layer is disposed on a side of the hardened layer away from the display module, and a refractive index of the hardened layer is greater than a refractive index of the anti-reflective layer; and
wherein a difference value between the refractive index of the hardened layer and the refractive index of the anti-reflective layer is 0.2.

According to an embodiment of the present disclosure, the refractive index of the anti-reflective layer is 1.4-1.75 and the refractive index of the hardened layer is 1.8-2.2.

According to an embodiment of the present disclosure, a thickness of the hardened layer and a film layer thickness of the anti-reflective layer are both less than 500 nm.

According to an embodiment of the present disclosure, the light enhancement layer further comprises a first buffer layer disposed on the display module, the hardened layer is disposed on the buffer layer, and the anti-reflective layer is disposed on the hardened layer.

According to an embodiment of the present disclosure, a thickness of the first buffer layer is less than 30 um.

According to a second aspect, a flexible display device is further provided, the flexible display device comprising:
a bendable region and a flat region disposed at at least one side of the bendable region, the flexible display device comprising:
a display module; and
a light enhancement layer disposed on the display module and disposed at least in the bendable region;
wherein the light enhancement layer comprises a hardened layer and an anti-reflective layer disposed on the hardened layer, the anti-reflective layer is disposed on a side of the hardened layer away from the display module, and a refractive index of the hardened layer is greater than a refractive index of the anti-reflective layer.

According to an embodiment of the present disclosure, the refractive index of the anti-reflective layer is 1.4-1.75 and the refractive index of the hardened layer is 1.8-2.2.

According to an embodiment of the present disclosure, a thickness of the hardened layer and a film layer thickness of the anti-reflective layer are both less than 500 nm.

According to an embodiment of the present disclosure, the light enhancement layer further comprises a first buffer layer disposed on the display module, the hardened layer is disposed on the first buffer layer.

According to an embodiment of the present disclosure, a thickness of the first buffer layer is less than 30 um.

According to an embodiment of the present disclosure, a material of the first buffer layer comprises any one of transparent polyimide and transparent glass.

According to an embodiment of the present disclosure, a reflectivity of the light enhancement layer is less than 5% and a light transmittance of the light enhancement layer is greater than 91%.

According to an embodiment of the present disclosure, a material of the hardened layer is polyethylene terephthalate.

According to an embodiment of the present disclosure, the display module further comprises a second buffer layer and a back plate, the second buffer layer is disposed above the back plate, and the back plate is disposed on a side of the display module away from the light enhancement layer.

According to an embodiment of the present disclosure, a material of the back plate comprises any one of polyacrylonitrile-based carbon fiber and polyurethane-based carbon fiber.

According to an embodiment of the present disclosure, a material of the second buffer layer comprises any one of foam and black thermoplastic polyurethane elastomer.

According to an embodiment of the present disclosure, the back plate is set as a hollow-out structure in the bendable region.

According to an embodiment of the present disclosure, the hollow-out structure comprises at least one of a grid hollow-out structure, a bar hollow-out structure, and a hole hollow-out structure.

According to an embodiment of the present disclosure, the display module further comprises a light absorbing layer disposed on a side of the display module close to the light enhancement layer.

According to an embodiment of the present disclosure, the display device comprising the display module, and the display module comprising: a back plate;
a support layer disposed on the back plate;
a flexible panel disposed over the support layer;
a polarizer disposed over the flexible panel, the light enhancement layer disposed over the polarizer; and
optical adhesive layers disposed between respective film layers.

### Beneficial Effects

In sum, an advantageous effect of an embodiment of the present disclosure is as follows:

An embodiment of the present disclosure provides a flexible display device. The flexible display device includes a bendable region and a flat region, the flexible display device further includes a display module and a light enhancement layer, the light enhancement layer includes a hardened layer and an anti-reflective layer disposed on a side of the hardened layer, and a refractive index of the hardened layer is greater than a refractive index of the anti-reflective layer. The light enhancement layer is disposed in the bendable region of the display module. When the flexible display device is bent, corresponding creases may be formed in the bendable region. When light corresponding to the creases passes through the light enhancement layer, and may be affected by the light enhancement layer, thereby reducing the visual effect of the user on the creases, and improving the display effect. Meanwhile, the display module in an embodiment of the present disclosure includes a fiber material, thereby further reducing the stress in the bendable region, and effectively improving the overall performance of the display device.

### BRIEF DESCRIPTION OF THE DRAWINGS

FIG. 1 is a structural schematic view of a flexible folding device in the related art;

FIG. 2 is a schematic plan view of a flexible display device according to an embodiment of the present disclosure;

FIG. 3 is a structural schematic view of film layers of a flexible display device according to an embodiment of the present disclosure;

FIG. 4 is a schematic structural view of a light enhancement layer according to an embodiment of the present disclosure;

FIG. 5 is a schematic diagram of a corresponding raster imaging effect of different film layer structures in the bendable region according to an embodiment of the present disclosure;

FIG. 6 is a structural schematic view of film layers of another flexible display device according to an embodiment of the present disclosure;

FIG. 7 is a structural schematic view of film layers of still another flexible display device according to an embodiment of the present disclosure;

FIG. 8 is a structural schematic view of a back plate according to an embodiment of the present disclosure;

FIG. 9 is a structural schematic view of a folded flexible display device in an embodiment of the present disclosure.

### EMBODIMENTS OF THE PRESENT INVENTION

The following description of the various embodiments is made with reference to the accompanying drawings to illustrate specific embodiments in which the present disclosure may be practiced.

With the development of the manufacturing technology of the display panel, especially the manufacturing technology of the flexible folding display device, higher requirements are put forward to the performance and the display effect of the flexible bending and folding display devices.

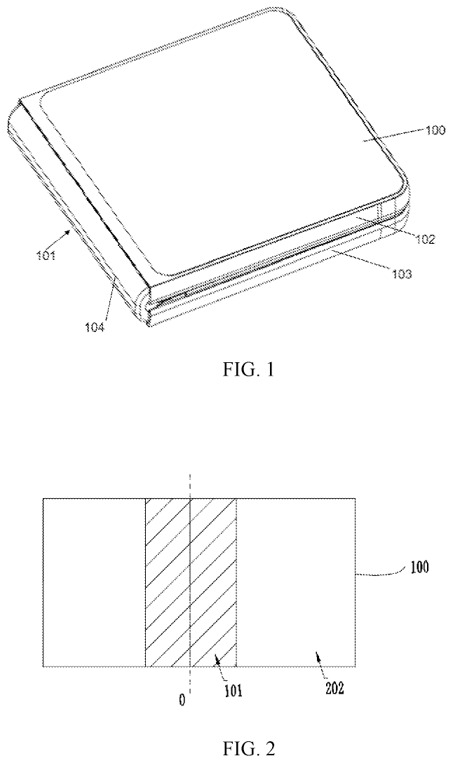

As shown in FIG. 1, FIG. 1 is a structural schematic view of a flexible folding device in the related art. The display device 100 includes a first folding portion 102 and a second folding portion 103. Meanwhile, the display device 100 further includes a bendable region 101. The display device 100 may be bent with respect to the bendable region 101. In a bending process, the first folding portion 102 is folded with respect to the second folding portion 103 and covers the second folding portion 103, thereby reducing a volume of the display device and facilitating carrying. However, in the related art, in a process that the display device 100 is bent and folded, when display device 100 is folded many times, a flexible screen in the display device may form a crease 104 at the bendable region 101, and the crease 104 may appear on both inner and outer sides of the flexible screen. For example, a plurality of creases may occur along a bending axis of the bendable region 101. Also, a bending effect of a flexible display device manufactured in the related art is not imperfect. For example, stress at the bendable region is larger, and the number and the depth of the creases 104 are further increased due to the larger stress. When the display device 100 is unfolded and displays images, a display effect at the bendable region may be directly affected by the creases 104 formed at the bendable region, thereby reducing the overall performance of the display panel.

An embodiment of the present disclosure provides a flexible display device to effectively improve a bending performance of the flexible display device and a display effect at the bendable region.

As shown in FIG. 2, FIG. 2 is a schematic plan view of a flexible display panel according to an embodiment of the present disclosure. The flexible display device 100 includes a bendable region 101 and a flat region 202. The flat region 202 may be disposed at at least one side of the bendable region 101. In an embodiment of the present disclosure, the bendable region 101 is disposed at an intermediate portion of the flat region 202, so that the flat region 202 may be bent or folded with respective to the bendable region 101. In an embodiment of the present disclosure, when the flexible display device is bent and folded, a folding stress of the flexible display device 100 at the bendable region 101 is smaller and the creases are smaller, thereby effectively improving the overall performance of the flexible display device.

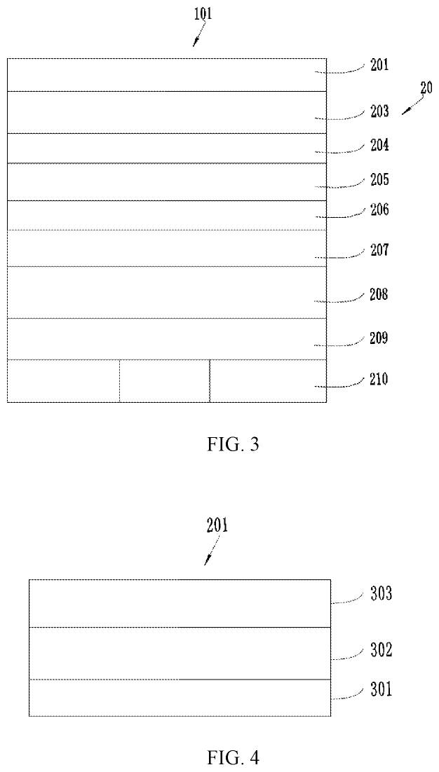

Further, as shown in FIG. 3, FIG. 3 is a structural schematic view of film layers of a flexible display device according to an embodiment of the present disclosure. The flexible display device includes a display module 20 and a light enhancement layer 201. The light enhancement layer 201 may be disposed on the display module 20. In an embodiment of the present disclosure, the light enhancement layer 201 is directly attached onto the display module 20.

Specifically, a film layer structure in which a plurality of layers are stacked on each other is disposed in the display module 20. In an embodiment of the present application, a first optical adhesive layer 203, a polarizer 204, a second optical adhesive layer 205, a flexible panel 206, a third optical adhesive layer 207, a support layer 208, a fourth optical adhesive layer 209, and a back plate 210 are further included in the display module 20.

The fourth optical adhesive layer 209 is disposed on the back plate 210, the support layer 208 is disposed on the fourth optical adhesive layer 209, and the fourth optical adhesive layer 209 adheres the back plate 210 to the support layer 208.

Meanwhile, the third optical adhesive layer 207 is disposed on the support layer 208, the flexible panel 206 is disposed on the third optical adhesive layer 207, and the third optical adhesive layer 207 adheres the flexible panel 206 to the support layer 208.

Further, the second optical adhesive layer 205 is disposed on the flexible panel 206, the polarizer 204 is disposed on the second optical adhesive layer 205, and the polarizer 204 is adhered to the flexible panel 206 by the second optical adhesive layer 205.

Meanwhile, the first optical adhesive layer 203 is disposed on the polarizer 204, the light enhancement layer 201 is disposed on the first optical adhesive layer 203, and the light enhancement layer 201 is adhered to the polarizer 204 of the display module 20 by the first optical adhesive layer 203. When the flexible display device is bent, each of the film layers in the display module and the light enhancement layer 201 are bent by a bending force.

In an embodiment of the present disclosure, the first optical adhesive layer 203, the second optical adhesive layer 205, and the third optical adhesive layer 207 may be the same optical adhesive layer, such as an optical pressure-sensitive adhesive layer, which is not specifically limited herein. Meanwhile, in an embodiment of the present disclosure, the back plate 210 may be selected as a carbon fiber lightweight material, such as any one of polyacrylonitrile-based carbon fiber and polyurethane-based carbon fiber. The back plate 210 is disposed in the bendable region 101 in a hollow-out manner. For example, the back plate is disposed as at least one of a grid hollow-out structure, a bar hollow-out structure, and a hole hollow-out structure in the bendable region.

In an embodiment of the present disclosure, since the light enhancement layer 201 is disposed in the bendable region 101 of the flexible display device, the display effect of the bendable region 101 is effectively improved by the light enhancement layer 201.

As shown in FIG. 4, FIG. 4 is a schematic structural view of a light enhancement layer according to an embodiment of the present disclosure. Specifically, the light enhancement layer 201 may include a substrate 301, a hardened layer 302, and an anti-reflective layer 303. The substrate 301 is disposed on the display module, the hardened layer 302 is disposed on the substrate 301, and the anti-reflective layer 303 is disposed on the hardened layer 302.

Further, in an embodiment of the present disclosure, the substrate 301 may be a first buffer layer by which other film layers are buffered and supported. The substrate 301 may selectively be a flexible substrate or a hard first buffer layer. When the substrate 301 is selected as a flexible substrate material layer, the flexible substrate material may be a flexible polyimide film layer(s), and the polyimide film layer includes a transparent film layer material. When the flexible substrate material is selected as a rigid substrate material, a material of the substrate 301 may be selected as a transparent glass layer.

In an embodiment of the present disclosure, the transparent glass layer is preferably ultra-thin glass (UTG). Therefore, while the thickness of the film layer is reduced, the folding stress in the bendable region is effectively improved, and the overall performance of the flexible display device is improved.

Specifically, in an embodiment of the present disclosure, a thickness of the substrate 301 is disposed to be less than 30 um, thereby effectively improving the bending performance in the bendable region.

Further, in the present embodiment, the hardened layer 302 is provided directly on the substrate 301. The hardened layer 302 has a certain hardness so that film layer(s) on the hardened layer 302 may be better supported and stabilized. Specifically, a material of the hardened layer 302 may selectively be an organic transparent film layer material. For example, the hardened layer 302 may be a polyethylene terephthalate or other transparent polymeric material layer.

In disposing the hardened layer 302, the hardened layer 302 in an embodiment of the present disclosure may be formed by being coated directly to the substrate 301 by a wet coating process, and dried to form a film.

Preferably, the anti-reflective layer 303 is disposed directly on the hardened layer 302. A hardness of the anti-reflective layer 303 is less than that of the hardened layer 302. In an embodiment of the present disclosure, a material of the anti-reflective layer 303 may be disposed as an inorganic material film layer such as silicon dioxide or the like. Therefore, the anti-reflective layer 303 and the hardened layer 302 are thus formed as an inorganic and organic combined film layer structure.

Preferably, film layer thicknesses of both the anti-reflective layer 303 and the hardened layer 302 are both less than 500 um. Preferably, in the embodiment of the present disclosure, the film layer thickness of the anti-reflective layer 303 may be disposed to the same as that of the hardened layer 302. Meanwhile, the film layer thicknesses of the anti-reflective layer 303 and the hardened layer 302 are both disposed as 200 nm at different locations. Thus, a film layer thickness of the light enhancement layer is guaranteed as thin as possible without affecting various properties thereof.

Specifically, in an embodiment of the present disclosure, the light enhancement layer 201 and a corresponding film layer structure thereof are disposed, so that a corresponding optical refractive index of the hardened layer 302 is greater than the refractive index of the anti-reflective layer 303. Preferably, the corresponding refractive index of the hardened layer 302 is 1.8-2.2, and the corresponding refractive index of the anti-reflective layer 303 is 1.4-1.75. Thus, the hardened layer 302 and the anti-reflective layer 303 have two different refractive indices. Preferably, the refractive index of the hardened layer 302 is set to 1.9, while the refractive index of the anti-reflective layer is set to 1.7. Alternatively, the refractive index of the hardened layer is set to 1.85, and the refractive index of the anti-reflective layer is set to 1.65. In an embodiment of the present disclosure, there is a difference value, for example, 0.2, between the corresponding optical refractive indices of the hardened layer and the anti-reflective layer, so as to further improve the effect of the light enhancement layer.

During a bending process of the flexible display device, the crease(s) may be formed on corresponding film layers at the bendable region 101 of the flexible display device. When light sequentially passes through the substrate 301, the hardened layer 302, and the anti-reflective layer 303 in the light enhancement layer, the film layers with different refractive indices have different effects on the light, because the refractive indices of the hardened layer 302 and the anti-reflective layer 303 are different, and the refractive index of the hardened layer 302 is greater than the refractive index of the anti-reflective layer 303.

Further, in an embodiment of the present disclosure, the light enhancement layer 201 may be set as a structure in which a plurality of film layers are stacked on each other. For example, the hardened layer 302 and the anti-reflective layer 303 are stacked in sequence with each other and are disposed as two layers. Therefore, the effect of the light enhancement layer 201 on light can be further improved. The degree of crease visualization of the display device is effectively reduced to improve the display effect of the device.

As shown in FIG. 5, FIG. 5 is a schematic diagram of a corresponding raster imaging effect of different film layer structures in the bendable region according to an embodiment of the present disclosure. “a” in FIG. 5 corresponds to a schematic diagram of a display effect of the bendable region after the display device is bent in the related art, and “b” in FIG. 5 corresponds to a schematic diagram of a display effect of the bendable region disposed with the light enhancement layer in an embodiment of the present disclosure. A plurality of creases 401 may be formed in the center of the bendable region, wherein the plurality of creases 401 may have a great effect on the display effect of the bendable region. In “a” in FIG. 5, it is viewed that in the bendable region 101, a curvature variation of a grating formed by the imaging of the creases 401 is larger. That is, an imaging stripe in the bendable region has a large fluctuation, which indicates that the creases have a larger unevenness. The display effect of the bendable region may be affected directly by the larger unevenness, thereby reducing the performance of the flexible display panel.

However, in “b” in FIG. 5, it is viewed that in the bendable region 101, a curvature variation corresponding to grating stripes formed by the creases 401 is smaller. That is, an overall fluctuation of the stripes is reduced. In this case, the unevenness of the corresponding creases in the bendable region 101 is improved. When a user views the bendable region 101, the bendable region has better visual unevenness, thereby effectively improving the display effect of the bendable region 101 of the flexible display panel.

Preferably, in an embodiment of the present disclosure, the light enhancement layer is disposed on the display module, and the hardened layer is disposed in the light enhancement layer, and also has better bending property. Therefore, when the flexible display device is bent, a bending radius of the bendable region 101 may be further reduced. In an embodiment of the present disclosure, bending radii of the corresponding film layers in the bendable region 101 may be less than 1.2 mm. In an ultra-small bending radius, the bendable region still has a better display effect. Therefore, a comprehensive performance of the flexible display device is effectively improved.

Preferably, with reference to FIGS. 2 to 4, in an embodiment of the present disclosure, a reflectivity of the light enhancement layer 201 is less than 5% and a light transmittance of the light enhancement layer 201 is greater than 91%. Therefore, the display effect at the bendable region is effectively improved.

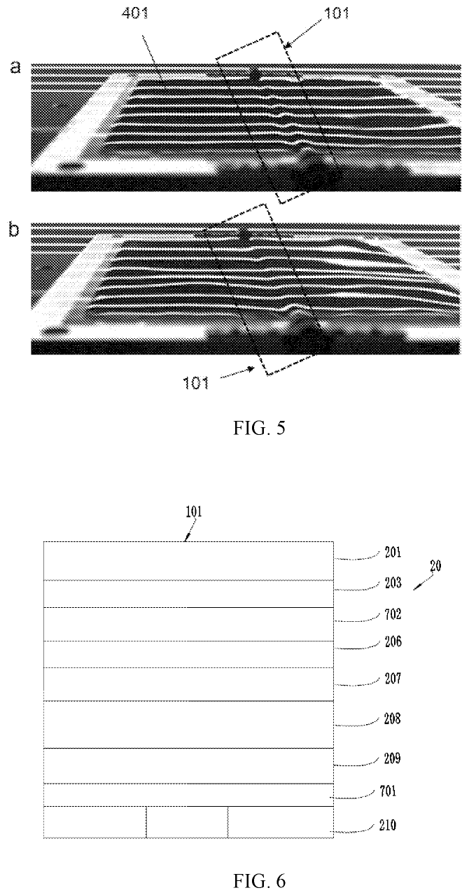

Further, as shown in FIG. 6, FIG. 6 is a structural schematic view of film layers of another flexible display device according to an embodiment of the present disclosure. With reference to the schematic view of the structure of the corresponding film layers in FIG. 3, in an embodiment of the present disclosure, the flexible display device includes a light enhancement layer 201 and a display module 20.

In an embodiment of the present application, a first optical adhesive layer 203, a light absorbing layer 702, a flexible panel 206, a third optical adhesive layer 207, a support layer 208, a fourth optical adhesive layer 209, a second buffer layer 701, and a back plate 210 disposed in sequence are further included in the display module 20.

In an embodiment of the present disclosure, film layer configurations and materials of the first optical adhesive layer 203, the flexible panel 206, the third optical adhesive layer 207, the support layer 208, and the fourth optical adhesive layer 209 are the same as that of the above film layer structures.

At the same time, the light absorbing layer 702 may be a black light absorbing layer, and the light absorbing layer 702 may also be a coated optical filter. By replacing the polarizer in the current display panel with the black light absorbing layer 702 and the coated optical filter, the thickness of the panel is effectively reduced. When a film layer having a small thickness is used, a corresponding bending stress of the curved film layer is further reduced, thereby effectively improving the bending performance of the bendable region and reducing the number of the creases in the bendable region, thereby improving the display effect of the flexible display panel in the bendable region. In an embodiment of the present disclosure, a film layer thickness of the black light absorbing layer 702 is, preferably, less than 50 um.

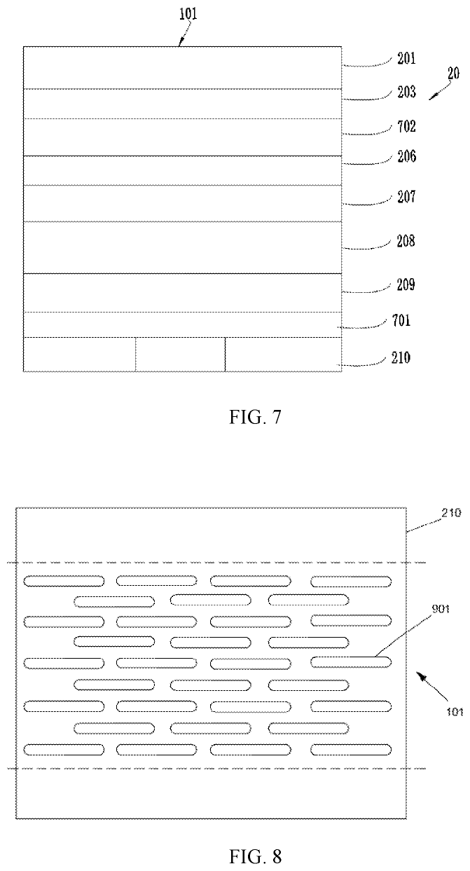

Preferably, the flexible display device in an embodiment of the present disclosure further includes the second buffer layer 701. As shown in FIG. 7, FIG. 7 is a structural schematic view of film layers of still another flexible display device according to an embodiment of the present disclosure. With reference to the structure of the flexible display device in FIG. 5, the second buffer layer 701 is disposed, so that the second buffer layer 701 may include foam and a thermoplastic elastic layer in an embodiment of the present disclosure.

Specifically, referring to FIG. 6, the second buffer layer 701 in FIG. 6 is set as a foam structure in which a porous structure is formed. Specifically, the porous structure within the foam structure may be a pore structure including open pores, closed pores, or a combination of the open pores and the closed pores. The specific porous structure may be disposed according to performance and function of actual products. When the flexible display device is subjected to an external force, such as due to bending or drop impact, the porous structure inside the flexible display device may effectively act as a buffer, thereby improving the performance of the flexible display device.

Referring in detail to FIG. 7, the second buffer layer 701 in FIG. 7 is provided as the thermoplastic elastomer layer. Preferably, the thermoplastic elastomer layer may be a black thermoplastic polyurethane elastomer.

The black thermoplastic polyurethane elastomer has a better elastic property. A thickness of the thermoplastic polyurethane elastomer is thinner, preferably, less than 40 um, thereby further reducing the thickness of this film layer and reducing the bending stress formed during bending.

As shown in Table 1, Table 1 is related to display devices in which the second buffer layers 701 are respectively formed by the above two different materials in embodiments of the present disclosure, wherein the structures of the other film layers are the same.

TABLE 1
performance parameters of the flexible display devices including
the second buffer layers of different materials

| | | | | bending | creases/ |
|---|---|---|---|---|---|
| | Thickness | Drop Pen | Drop Ball | performance | bars |
| Scheme 1 | 45 um | 9 cm | 3 cm | high | 6-10 |
| Scheme 2 | 45 um | 7 cm | 2 cm | high | 3-5 |

The second buffer layer in Scheme 1 includes the foam and the second buffer layer in Scheme 2 includes the black thermoplastic polyurethane elastomer. The second buffer layer in Scheme 1 and the second buffer layer in Scheme 2 are separately bent. From the performance data in the above table, it can be seen that the flexible display devices formed by the foam and the black thermoplastic polyurethane elastomer both have better performance. With respect to a case that the second buffer layer is a foam material, when the second buffer layer is a black thermoplastic polyurethane elastomer, the flexible display device has superior performance in both the drop pen test and the drop ball test. Meanwhile, the number of the creases in the bendable region of the flexible display device becomes smaller, for example, only 3 to 5 creases, thereby further improving the display effect in the bendable region.

Further, in an embodiment of the present disclosure, when the second buffer layer is the black thermoplastic polyurethane elastomer, the thickness of the second buffer layer may be further reduced. For example, in the case that the thickness of the second buffer layer is set as 40 um, the corresponding flexible display device still has superior performance and is thinner in thickness.

In an embodiment of the present disclosure, the back plate 210 is disposed with a lightweight material, such as a carbon fiber material that is easy to be bent. Preferably, the back plate 210 is disposed with a material such as the polyacrylonitrile-based carbon fiber and the polyurethane-based carbon fiber. A thickness of the back plate 210 is set to be less than 90 um, so that a light-weight setting is realized when the performance of the display device is ensured.

As shown in Table 2, Table 2 is the corresponding bending stress when the backplates in the embodiments of the present disclosure are of different materials.

TABLE 2
the corresponding bending stress when the backplates in the embodiments
of the present disclosure are of different materials

| | | Laminate Member | Laminate Member |
|---|---|---|---|
| | Experimental | Including | Including Carbon |
| | Group | Iron-Nickel | Fiber |
| Rebound | Scheme 3 | 18.1 | 14.5 |
| Force/N | Scheme 4 | 33.1 | 26.2 |

In an embodiment of the present disclosure, Scheme 3 is a display device manufactured using a current back plate with a laminate member including iron-nickel, and Scheme 4 is a display device manufactured using a back plate with a laminate member including the carbon fiber in an embodiment of the present disclosure. The other common film layers in the current display device and the display device in an embodiment of the present disclosure are of the same thickness and material.

Specifically, in Scheme 3, a bending radius of the display device is 1.5 mm. In Scheme 4, the bending radius of the display device is 1 mm The display devices in Scheme 3 and Scheme 4 are bent, respectively. When they are bent with the same bending radius, the back plate in an embodiment of the present disclosure has a lower rebound force than the back plate including iron-nickel. When they are bent with the same bending radius, the display device including the back plate having the carbon fiber has better bending performance.

Preferably, as shown in FIG. 8, FIG. 8 is a structural schematic view of a back plate according to an embodiment of the present disclosure. In the following embodiment, the structure in which the back plate 210 is disposed as a bar hollow-out structure in the bendable region 101 will be described. A plurality of hollow-out bars 901 are arranged on the back plate 210 alternately in sequence so that distances between the two adjacent hollow-out bars 901 are the same, thereby ensuring the consistency of the performance of the back plate. In an embodiment of the present disclosure, a plurality of hollow-out bars are disposed in the bendable region 101, so that when the bendable region 101 is bent, the hollow-out bars may effectively reduce the bending stress of the back plate and improve the bending performance of the flexible display device. Meanwhile, the hollow-out bars may further reduce the weight of the back plate, thereby realizing a lighter and thinner design of the flexible display device. Preferably, the back plate 210 may be set as a hollow-out structure of other shapes, such as a plurality of hollow-out holes, a hollow-out ellipse, or the like. The hollow-out structure is disposed to effectively reduce a deformation stress between the inner film layers of the bendable region 101.

In an embodiment of the present disclosure, in manufacturing the back plate, the polyacrylonitrile-based carbon fiber may be processed by as-spun fiber carbonization, prepreg, laminating, hot-press molded, laser-cut, and coating processes, to form a back plate having a fiber structure. When the back plate is bent, a rebound force effect may be effectively reduced by the fiber structure, thereby reducing creases in the bendable region, and improving the display effect thereof.

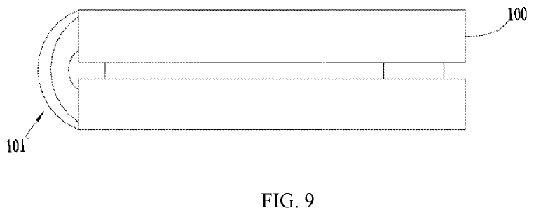

Preferably, as shown in FIG. 9, FIG. 9 is a structural schematic view of a folded flexible display device in an embodiment of the present disclosure. When the flexible display device 100 is folded, its volume and occupied area are reduced by half, and at the bendable region 101, the flexible display device 100 has a smaller bending radius. In an embodiment of the present disclosure, the bending radius is less than 1.2 mm. Meanwhile, the number of creases on the corresponding film layer in the bendable region 101 is relatively smaller. When viewed by the user, the creases in the bendable region 101 are less visible, thereby effectively improving the display effect of the flexible display device.

In an embodiment of the present disclosure, the flexible display device may be applied to any product or component having a flexible bending or folding function, such as a mobile phone, a computer, a notebook computer, a digital photo frame, or the like, the specific type of which is not specifically limited.

In sum, a flexible display device in an embodiment of the present disclosure has been described in detail above. The principles and implementations of the present disclosure have been described herein with reference to specific examples. The description of the above embodiments is merely intended to assist in understanding technical solutions and the core idea of the present disclosure. Although the present disclosure has been described in terms of preferred embodiments, the foregoing preferred embodiments are not intended to limit the present disclosure. Various changes and modifications may be made by the ordinary skilled in the art without departing from the spirit and scope of the present disclosure. Therefore, the scope of the present disclosure is based on the scope defined in the claims.

What is claimed is:

1. A flexible display device comprising a bendable region and a flat region disposed at at least one side of the bendable region, the flexible display device comprising:
a display module; and
a light enhancement layer disposed on the display module and disposed at least in the bendable region;
wherein the light enhancement layer comprises a hardened layer and an anti-reflective layer disposed on the hardened layer, the anti-reflective layer is disposed on a side of the hardened layer away from the display module, and a refractive index of the hardened layer is greater than a refractive index of the anti-reflective layer; and
wherein a difference value between the refractive index of the hardened layer and the refractive index of the anti-reflective layer is 0.2.

2. The flexible display device according to claim 1, wherein the refractive index of the anti-reflective layer is 1.4-1.75 and the refractive index of the hardened layer is 1.8-2.2.

3. The flexible display device according to claim 1, wherein a thickness of the hardened layer and a film layer thickness of the anti-reflective layer are both less than 500 nm.

4. The flexible display device according to claim 1, wherein the light enhancement layer further comprises a first buffer layer disposed on the display module, the hardened layer is disposed on the buffer layer, and the anti-reflective layer is disposed on the hardened layer.

5. The flexible display device according to claim 4, wherein a thickness of the first buffer layer is less than 30 um.

6. A flexible display device comprising a bendable region and a flat region disposed at at least one side of the bendable region, the flexible display device comprising:
a display module; and
a light enhancement layer disposed on the display module and disposed at least in the bendable region;
wherein the light enhancement layer comprises a hardened layer and an anti-reflective layer disposed on the hardened layer, the anti-reflective layer is disposed on a side of the hardened layer away from the display module, and a refractive index of the hardened layer is greater than a refractive index of the anti-reflective layer.

7. The flexible display device according to claim 6, wherein the refractive index of the anti-reflective layer is 1.4-1.75 and the refractive index of the hardened layer is 1.8-2.2.

8. The flexible display device according to claim 6, wherein a thickness of the hardened layer and a film layer thickness of the anti-reflective layer are both less than 500 nm.

9. The flexible display device according to claim 6, wherein the light enhancement layer further comprises a first buffer layer disposed on the display module, the hardened layer is disposed on the first buffer layer.

10. The flexible display device according to claim 9, wherein a thickness of the first buffer layer is less than 30 um.

11. The flexible display device according to claim 9, wherein a material of the first buffer layer comprises any one of transparent polyimide and transparent glass.

12. The flexible display device according to claim 6, wherein a reflectivity of the light enhancement layer is less than 5% and a light transmittance of the light enhancement layer is greater than 91%.

13. The flexible display device according to claim 6, wherein a material of the hardened layer is polyethylene terephthalate.

14. The flexible display device according to claim 6, wherein the display module further comprises a second buffer layer and a back plate, the second buffer layer is disposed above the back plate, and the back plate is disposed on a side of the display module away from the light enhancement layer.

15. The flexible display device according to claim 14, wherein a material of the back plate comprises any one of polyacrylonitrile-based carbon fiber and polyurethane-based carbon fiber.

16. The flexible display device according to claim 14, wherein a material of the second buffer layer comprises any one of foam and black thermoplastic polyurethane elastomer.

17. The flexible display device according to claim 14, wherein the back plate is set as a hollow-out structure in the bendable region.

18. The flexible display device according to claim 17, wherein the hollow-out structure comprises at least one of a grid hollow-out structure, a bar hollow-out structure, and a hole hollow-out structure.

19. The flexible display device according to claim 6, wherein the display module further comprises a light absorbing layer disposed on a side of the display module close to the light enhancement layer.

20. The flexible display device according to claim 1, the flexible display device further comprising:
a back plate;
a support layer disposed on the back plate;
a flexible panel disposed over the support layer;
a polarizer disposed over the flexible panel, the light enhancement layer disposed over the polarizer; and
optical adhesive layers disposed between respective film layers.
